(19) United States
(12) Patent Application Publication
(10) Pub. No.: US 2017/0301306 A1
(43) Pub. Date: Oct. 19, 2017

(54) Gate Driving Method and Device

(71) Applicants: BOE TECHNOLOGY GROUP CO., LTD., Beijing (CN); Hefei BOE Optoelectronics Technology Co., Ltd., Hefei, Anhui (CN)

(72) Inventors: Liangliang ZHENG, Beijing (CN); Jian HE, Beijing (CN)

(21) Appl. No.: 15/516,207

(22) PCT Filed: Jan. 5, 2016
(86) PCT No.: PCT/CN2016/070092

§ 371 Date: Mar. 31, 2017

(30) Foreign Application Priority Data
Aug. 20, 2015 (CN) 201510514174.4

(51) Int. Cl. G09G 3/36

(52) U.S. Cl. CPC G09G 3/3677; G09G 3/3648; G09G 2310/0291; G09G 2330/023; G09G 2310/08

(57) ABSTRACT

The present invention provides a gate driving method and a gate driving device for a liquid crystal display panel. The gate driving method includes: dividing a gate driving device into a plurality of gate driving units according to positions of the plurality of output channels of the gate driving device relative to a central output channel, and respectively setting bias currents outputted from the plurality of gate driving units such that the smaller an average distance of output channels driven by the gate driving unit from the central output channel is, the smaller the bias current outputted by the gate driving unit is set. The present invention can lower power consumption of the gate driving method and further lower power consumption of the liquid crystal panel.

### TECHNICAL FIELD

The present invention relates to the field of liquid crystal displays, and particularly relates to a gate driving method and a gate driving device.

### BACKGROUND

In recent years, portable electronic products and flat-panel display products rise along with the development of semiconductor technologies. Thin film transistor (TFT) liquid crystal displays, due to their advantages such as low operating voltage, free of scattered radiation, light weight, small volume and the like, have gradually become standard output devices of various digital products. As various display devices such as mobile phones, PADs, etc. have higher system integration and smaller thickness, system CPU has advanced in succession to be of dual-core, quad-core, octa-core, and even more cores from previous single-core, power consumption of the system becomes higher. Because the market has higher and higher demand for battery life of display devices such as mobile phones, PADs, etc., continuing to lower power consumption of the display devices becomes a goal that system manufacturers and panel manufacturers always pursue.

TFT liquid crystal display typically includes a pixel matrix arranged in horizontal and vertical directions. When the TFT liquid crystal display operates to display an image, a gate input signal generated by a shift register scans rows of pixels sequentially from the first row to the last row, so that each row of TFT units are switched on in turn, and pixel voltages outputted from a source driving chip are sequentially written into corresponding pixel storage capacitors.

FIG. 1 illustrates a schematic diagram of a conventional discrete driving structure of a TFT liquid crystal display (LCD). The system sends image information to a timing control (TCON) 103. TCON 103 outputs DATA/LOAD/POL/CLK signals to a source driving chip (Source IC) 101, and outputs STV/CPV/OE signals to a gate driving chip (gate driving IC) 102.

FIG. 2 illustrates a schematic diagram of a fan-out area of a gate driving IC. As shown in FIG. 2, a gate output channel (central channel) at the central portion of a panel area where the gate driving IC is located has a smaller fan-out resistance, whereas a gate output channel (marginal channel) at the marginal portion of the panel area has a larger fan-out resistance, that is, fan-out resistance of a gate output channel increases as a distance between the gate output channel and the gate driving IC increases.

FIG. 3 illustrates a schematic diagram of output delays of gate signals due to panel loads, that is, phase delay occurs to an output signal of the gate driving IC due to presence of the panel load.

As resolution of the panel increases gradually, the number of output channels of a gate driving IC increases rapidly, for example, from previous 384 output channels (384 CH) to 960 CH, and even to 1600 CH. Under the present manufacturing process, i.e., under the condition of keeping line widths and line spacings of the gate output channels of the fan-out area of the gate driving IC unchanged, the fan-out area of the gate driving IC inevitably becomes larger, so that bezel of the panel becomes wide, which goes against the market demand for narrow bezel. Therefore, in order to satisfy the market demand, panel designers have to decrease the line widths and line spacings of the gate output channels, which inevitably leads to increased line resistances of the gate output channels and bigger difference between resistance values of the central channel and the marginal channel among the gate output channels. For example, the fan-out resistance of the central channel is 100 ohms only, whereas the fan-out resistance of the marginal channel is 7000 ohms. As shown in FIG. 3, the larger the panel load (R*C) is, the more the phase of an output signal from the gate driving IC delays.

To ensure that a panel can display normally, a solution in which output bias currents of the gate driving IC are uniformly set according to the panel load of the marginal channel is adopted in the prior art, but this solution does not allow partial adjustment of the output bias currents based on different output channels of the gate driving IC. Because the panel load of the marginal channel is larger and the panel load of the central channel is smaller, in the case of ensuring that the gate channel corresponding to the marginal channel can be driven normally, the gate channel corresponding to the central marginal is over-driven although the gate channel corresponding to the marginal channel is driven normally, which leads to significantly increased power consumption of the panel.

### SUMMARY

An object of the present invention is at least to provide a gate driving device with low power consumption and a gate driving method.

According to an aspect of the present invention, there is provided a gate driving method for a liquid crystal display (LCD) panel, the LCD panel includes a gate driving device for driving a plurality of output channels, and the gate driving method includes: dividing the gate driving device into a plurality of gate driving units according to positions of the plurality of output channels relative to a central output channel of the plurality of output channels, and respectively setting bias currents outputted from the plurality of gate driving units such that the smaller an average distance of output channels driven by the gate driving unit from the central output channel is, the smaller the bias current outputted from the gate driving unit is set.

According to another aspect of the present invention, there is provided a gate driving device for a LCD panel, the gate driving device is configured to drive a plurality of output channels and includes: a gate driving unit division part configured to divide the gate driving device into a plurality of gate driving units according to positions of the plurality of output channels relative to a central output channel of the plurality of output channels; and a bias current set part configured to respectively set bias currents outputted from the plurality of gate driving units such that the smaller an average distance of output channels driven by the gate driving unit from the central output channel is, the smaller the bias current outputted from the gate driving unit is set.

Correspondence between the output channels of the gate driving device and the bias currents may be stored in a look-up table.

Corresponding bias currents may be set by a timing controller using the look-up table.

The corresponding bias currents may be set by hardware pins.

The bias currents may be classified into a maximum bias current, a medium bias current and a minimum bias current.

The bias currents may be classified into a maximum bias current, a middle maximum bias current, a large bias current, a middle large bias current, a medium bias current, a middle medium bias current, a small bias current and a minimum bias current.

The gate driving device may be divided into 15 gate driving units, wherein the bias current outputted from the (8−i)-th gate driving unit is set equal to the bias current outputted from the (8+i)-th gate driving unit, and the bias current outputted from the (7+i)-th gate driving unit is set smaller than the bias current outputted from the (8+i)-th gate driving unit, where 0<i<8, and i is an integer.

The gate driving device may be divided into (2n−1) gate driving units, wherein the bias current outputted from the (n−i)-th gate driving unit is set equal to the bias current outputted from the (n+i)-th gate driving unit, and the bias current outputted from the (n+i−1)-th gate driving unit is set smaller than the bias current outputted from the (n+i)-th gate driving unit, where 0<i<n, and i and n are integers. The bias currents are classified into n different kinds of bias currents. In addition, an average distance of output channels driven by the (n+i−1)-th gate driving unit from the central output channel is smaller than an average distance of output channels driven by the (n+i)-th gate driving unit from the central output channel.

In embodiments of the present invention, to further reduce power consumption of a LCD panel and considering signal phase delay of different output channels of a gate driving IC due to different panel loads caused by channel resistance of a fan-out area, the present invention provides a gate driving device having low power consumption and a gate driving method, in which in a central output channel area close to the gate driving IC (in this area, the panel has relatively small fan-out resistance, and signal delay of the output channel of the gate driving IC is relatively small), bias current of an output OP of the gate driving IC may be set to be relatively small; in a marginal output channel area away from the gate driving IC (in this area, the panel has relatively large fan-out resistance, and signal delay of the output channel of the gate driving IC is relatively large), bias current of an output OP of the gate driving IC may be set to be relatively large. With the design of the gate driving IC of the embodiments of the present invention, power consumption of the gate driving IC can be reduced to the largest extent while achieving normal driving and display of a panel, which further lowers power consumption of the LCD display.

### BRIEF DESCRIPTION OF THE DRAWINGS

To better understand various exemplary embodiments, specific embodiments of the present invention will be described with reference to the accompanying drawings, in which:

FIG. 1 shows a schematic diagram of a conventional discrete driving structure of a TFT LCD;

FIG. 2 shows a schematic diagram of a fan-out area of an existing gate driving chip;

FIG. 3 shows a schematic diagram of output delays of gate signals due to panel loads;

FIG. 4 shows a look-up table of bias currents outputted by operational amplifiers of a gate driving chip according to an embodiment of the present invention;

FIG. 5 shows a hardware configuration of a gate driving chip which outputs a bias current through an operational amplifier according to an embodiment of the present invention;

FIG. 6 shows a flow chart of a gate driving method according to an embodiment of the present invention;

FIG. 7 shows a block diagram of a gate driving device according to an embodiment of the present invention;

FIG. 8 shows a look-up table for setting gate bias currents according to an embodiment of the present invention;

FIG. 9 shows a specific look-up table for setting gate bias currents according to an embodiment of the present invention; and

FIG. 10 shows another specific look-up table for setting gate bias currents according to an embodiment of the present invention.

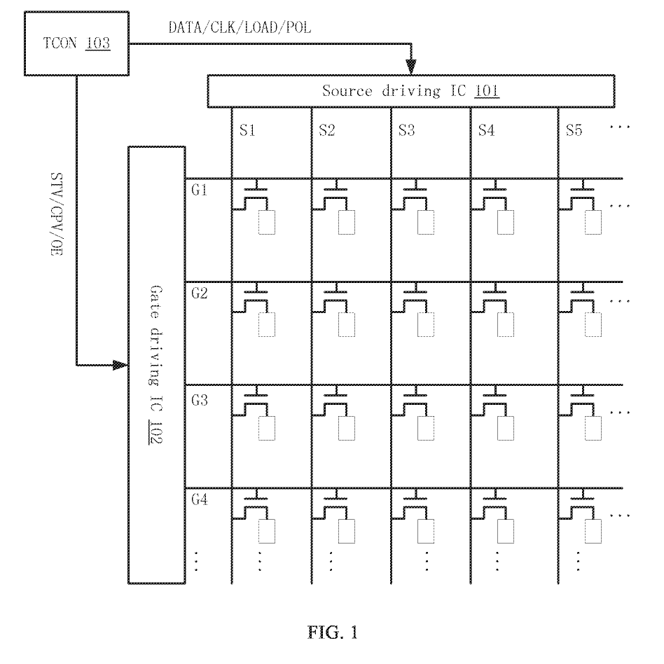

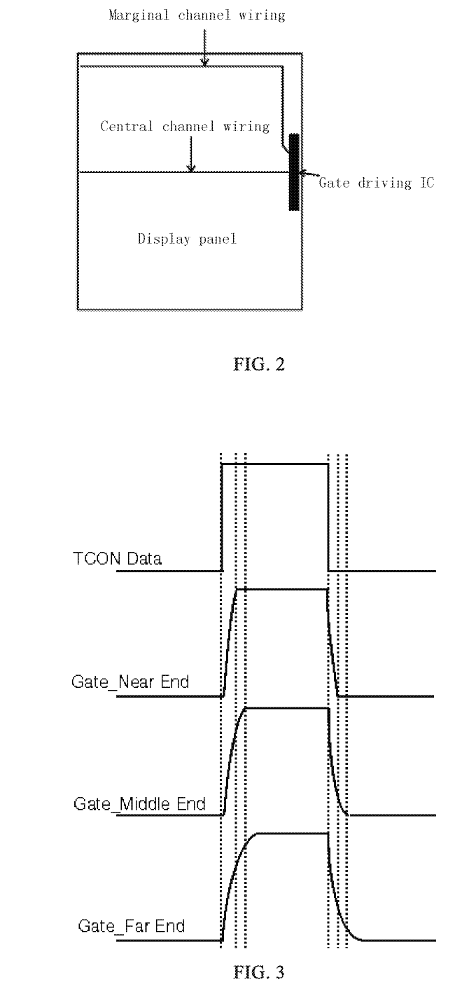

### DETAILED DESCRIPTION OF THE EMBODIMENTS

Embodiments of the present invention will be described in detail with reference to the accompanying drawings.

Configuration of a gate driving chip (gate driving IC) with low power consumption sought to be protected by the present invention is applicable to an existing LCD panel, wherein the gate driving IC has a relatively large fan-out resistance at a marginal position of the panel, and a relatively small fan-out resistance at a central position of the panel. In consideration of this characteristic of the fan-out resistance of the gate driving IC, providing a relatively low output bias current near the central position of the panel may be sufficient to drive a gate near the central position to work.

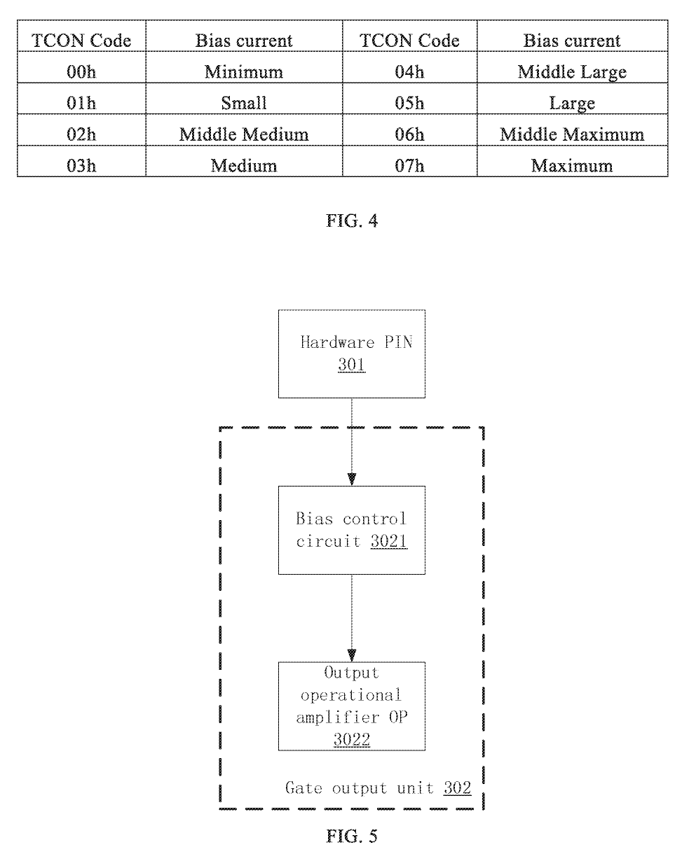

FIG. 4 shows a look-up table of bias currents outputted by operational amplifiers (OPs) of a gate driving chip according to an embodiment of the present invention, in which the outputs of the OPs of the gate driving IC are adjustable. As shown in FIG. 4, gate driving bias currents may be set through software programming. Specifically, corresponding bias currents are set for switched-on gates according to different TCON codes.

FIG. 5 shows a hardware configuration of a gate driving IC which outputs a bias current through an OP according to an embodiment of the present invention, in which a hardware PIN 301 is connected to a gate output unit 302, and the gate output unit 302 includes a bias control circuit 3021 and an output operational amplifier (OP) 3022. With the hardware of the gate driving IC for setting a bias current, the bias current of the gate driving IC is modified by configuring resistors.

An embodiment of the present invention provides a gate driving method for a LCD panel, the LCD panel includes a gate driving device for driving a plurality of output channels, and the gate driving method includes: dividing the gate driving device into a plurality of gate driving units according to positions of the plurality of output channels relative to a central output channel of the plurality of output channels, and respectively setting bias currents outputted from the plurality of gate driving units such that the smaller an average distance of output channels driven by the gate driving unit from the central output channel is, the smaller the bias current outputted by the gate driving unit is set.

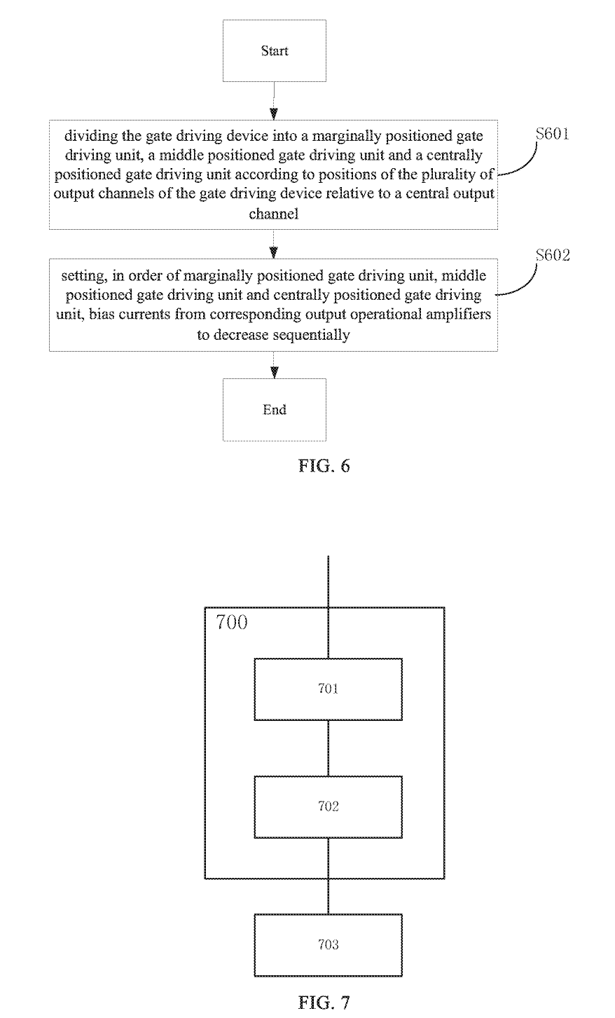

For example, FIG. 6 shows a flow chart of a gate driving method used for driving gates of a LCD panel according to an embodiment of the present invention. As shown in FIG. 6, the gate driving method includes: dividing the gate driving device into a marginally positioned gate driving unit, a middle positioned (i.e., positioned between a marginal position and a central position) gate driving unit and a centrally positioned gate driving unit according to positions of the plurality of output channels of the gate driving device relative to a central output channel (S601); and setting, in order of marginally positioned gate driving unit, middle positioned gate driving unit and centrally positioned gate driving unit, bias currents outputted by corresponding output operational amplifiers to decrease sequentially (S602).

Specifically, correspondence between the positions of the output channels of the gate driving device and the bias currents may be stored in a look-up table, Corresponding bias currents may be set by a timing controller using the look-up table, that is to say, the bias currents may be set by means of software as shown in FIG. 4. Also, corresponding bias currents may be set by hardware pins, that is to say, the bias currents may be set by means of hardware as shown in FIG. 5. The bias currents may be classified into a maximum bias current, a medium bias current and a minimum bias current. Further, the bias currents may be classified into a maximum bias current, a middle maximum bias current, a large bias current, a middle large bias current, a medium bias current, a middle medium bias current, a small bias current and a minimum bias current.

Another embodiment of the present invention provides a gate driving device for a LCD panel, and the gate driving device is configured to drive a plurality of output channels and includes: a gate driving unit division part configured to divide the gate driving device into a plurality of gate driving units according to positions of the plurality of output channels relative to a central output channel of the plurality of output channels; and a bias current set part configured to respectively set bias currents outputted from the plurality of gate driving units such that the smaller an average distance of output channels driven by the gate driving unit from the central output channel is, the smaller the bias current outputted by the gate driving unit is set.

For example, FIG. 7 shows a gate driving device 700 used for driving gates of a LCD panel according to an embodiment of the present invention. The gate driving device 700 includes a gate driving unit division part 701, which is configured to divide the gate driving device into a marginally positioned gate driving unit, a middle positioned (i.e., positioned between a marginal position and a central position) gate driving unit and a centrally positioned gate driving unit according to positions of the plurality of output channels of the gate driving device relative to a central output channel; and a bias current set part 702, which is configured to set, in order of marginally positioned gate driving unit, middle positioned gate driving unit and centrally positioned gate driving unit, bias currents outputted by corresponding output operational amplifiers to decrease sequentially. In addition, the bias currents are supplied to the respective pixel units 703 for driving.

In the above embodiment, based on similar division standard, the marginally positioned gate driving unit and the middle positioned gate driving unit may be further divided, respectively.

A gate driving method and a gate driving device according to embodiments of the present invention are described in detail below in conjunction with a specific division standard.

Thereinafter, for convenience of description, function f(x/y) is defined to represent that x divided by y is rounded down to ten (i.e., obtaining the tens and upper digits by calculation, and assigning 0 to the units and lower digits directly), but not rounded to the nearest ten, e.g., f(x/y)=f(3200/15)=210.

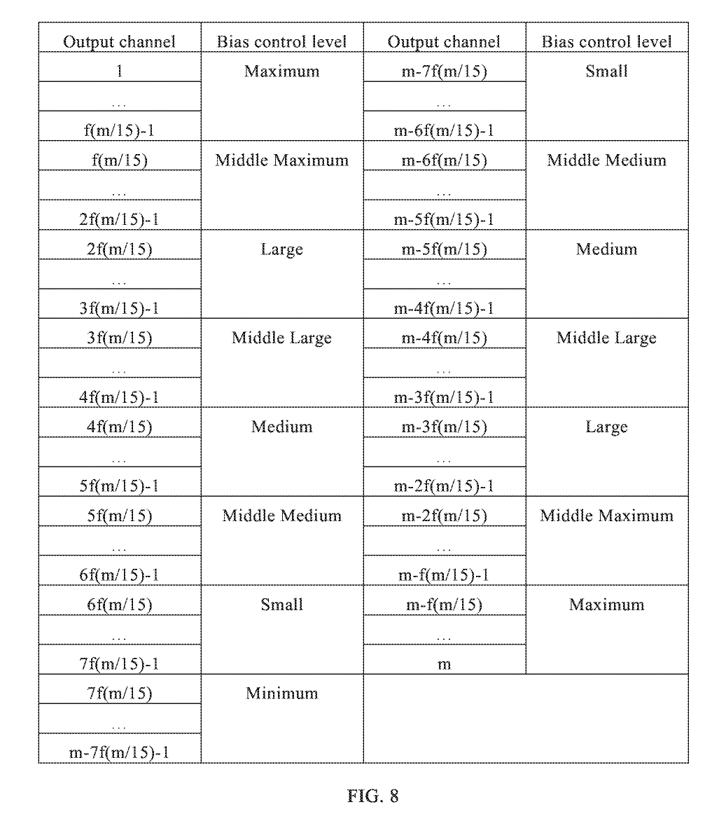

As shown in. FIG. 8, assuming that the total number of output channels of a gate driving IC is m, by debugging, the quiescent bias current corresponding to the output OP for the 1 CH to [f(m/15)−1]CH and [m−f(m/15)CH to m CH among the output channels of the gate driving IC is set to be maximum; the quiescent bias current corresponding to the output OP for the f(m/15)CH to [2f(m/15)−1]CH and [m−2f(m/15)CH to [m−f(m/15)−1]CH among the output channels is set to be middle maximum; the quiescent bias current corresponding to the output OP for the 2f(m/15)CH to [3f(m/15)−1]CH and [m−3f(m/15)]CH to [m−2f(m/15)−1]CH among the output channels is set to be large; the quiescent bias current corresponding to the output OP for the 3f(m/15)CH to [4f(m/15)−1]CH and [m−4f(m/15)]CH to [m−3f(m/15)−1]CH among the output channels is set to be middle large; the quiescent bias current corresponding to the output OP for the 4f(m/15)CH to [5f(m/15)−1]CH and [m−5f(m/15)]CH to [m−4f(m/15)−1]CH among the output channels is set to be medium; the quiescent bias current corresponding to the output OP for the 5f(m/15)CH to [6f(m/15)−1]CH and [m−6f(m/15)]CH to [m−5f(m/15)−1]CH among the output channels is set to be middle medium; the quiescent bias current corresponding to the output OP for the 6f(m/15)CH to [7f(m/15)−1]CH and [m−7f(m/15)]CH to [m−6f(m/15)−1]CH among the output channels is set to be small; and the quiescent bias current corresponding to the output OP for the 7f(m/15)CH to [m−7f(m/15)−1]CH among the output channels is set to be minimum.

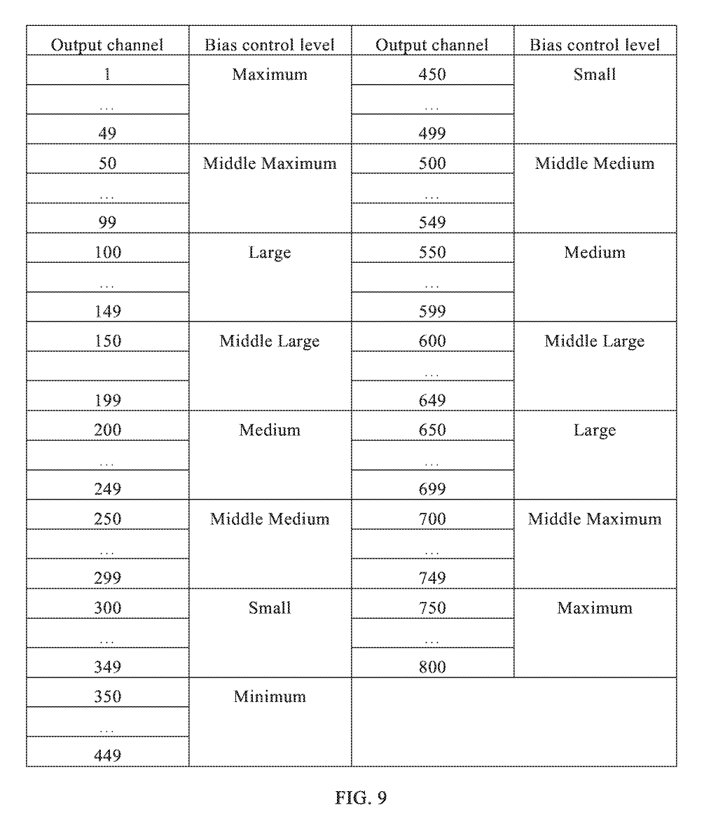

FIG. 9 shows a specific example of the look-up table shown in FIG. 8. Specifically, FIG. 9 shows a case where the total number m in the example shown in FIG. 8 is 800. As shown in FIG. 9, in the case of WXGA resolution (1280*800), by debugging, the quiescent bias current corresponding to the output OP for the 1 CH to 49 CH and 750 CH to 800 CH among the output channels of the gate driving IC is set to be maximum; the quiescent bias current corresponding to the output OP for the 50 CH to 99 CH and 700 CH to 749 CH among the output channels is set to be middle maximum; the quiescent bias current corresponding to the output OP for the 100 CH to 149 CH and 650 CH to 699 CH among the output channels is set to be large; the quiescent bias current corresponding to the output OP for the 150 CH to 199 CH and 600 CH to 649 CH among the output channels is set to be middle large; the quiescent bias current corresponding to the output OP for the 200 CH to 249 CH and 550 CH to 599 CH among the output channels is set to be medium; the quiescent bias current corresponding to the output OP for the 250 CH to 299 CH and 500 CH to 549 CH among the output channels is set to be middle medium; the quiescent bias current corresponding to the output OP for the 300 CH to 349 CH and 450 CH to 499 CH among the output channels is set to be small; and the quiescent bias current corresponding to the output OP for the 350 CH to 449 CH among the output channels is set to be minimum.

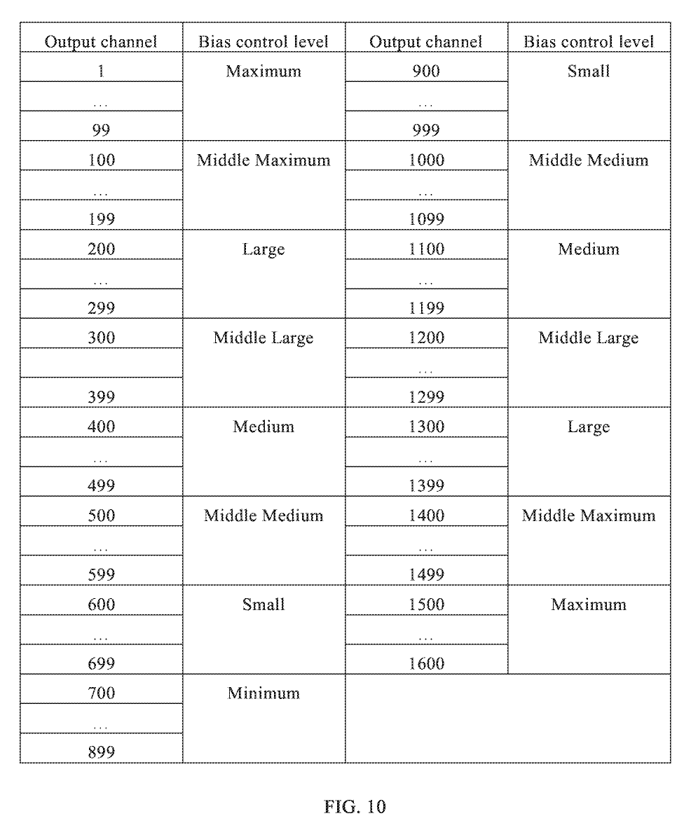

FIG. 10 shows another specific example of the look-up table shown in FIG. 28. Specifically, FIG. 10 shows a case where the total number m in the example shown in FIG. 8 is 1600. As shown in FIG. 10, in the case of WQXGA resolution (2560*1600), by debugging, the quiescent bias current corresponding to the output OP for the 1 CH to 99 CH and 1500 CH to 1600 CH among the output channels of the gate driving IC is set to be maximum; the quiescent bias current corresponding to the output OP for the 100 CH to 199 CH and 1400 CH to 1499 CH among the output channels is set to be middle maximum; the quiescent bias current corresponding to the output OP for the 200 CH to 299 CH and 1300 CH to 1399 CH among the output channels is set to be large; the quiescent bias current corresponding to the output OP for the 300 CH to 399 CH and 1200 CH to 1299 CH among the output channels is set to be middle large; the quiescent bias current corresponding to the output OP for the 400 to 499 CH and 1100 CH to 1199 CH among the output channels is set to be medium; the quiescent bias current corresponding to the output OP for the 500 CH to 599 CH and 1000 CH to 1099 CH among the output channels is set to be middle medium; the quiescent bias current corresponding to the output OP for the 600 CH to 699 CH and 900 CH to 999 CH among the output channels is set to be small; and the quiescent bias current corresponding to the output OP for the 700 CH to 899 CH among the output channels is set to be minimum.

FIGS. 8 to 10 merely illustrate exemplary ways in which the output OPs (operational amplifiers) of the gate driving IC output bias currents. It should be understood that it is also feasible to dynamically adjust the bias current corresponding to an output OP of the gate driving IC, depending on the output channel of the gate driving IC.

The gate driving device may be divided into (2n−1) gate driving units, and the bias currents may be classified into n different bias currents. In this case, the bias current outputted from the (n−i)-th gate driving unit is set equal to the bias current outputted from the (n+i)-th gate driving unit, and the bias current outputted from the (n+i−1)-th gate driving unit is set smaller than the bias current outputted from the (n+i)-th gate driving unit, where 0<i<n, and i and n are integers. The bias currents are classified into n different kinds of bias currents. In addition, an average distance of output channels driven by the (n+i−1)-th gate driving unit from the central output channel is smaller than an average distance of output channels driven by the (n+i)-th gate driving unit from the central output channel.

The present invention further discloses a display apparatus including a plurality of pixel units and the above-described gate driving device. The display apparatus can be applicable to any product or component having a display function such as a liquid crystal panel, an electronic paper, a mobile phone, a tablet computer, a television, a monitor, a notebook computer, a digital photo frame, a navigator, etc.

The present invention has been specifically illustrated and described with reference to exemplary embodiments of the present invention, but those skilled in the art should understand various variations in forms and details may be made to the embodiments without departing from the spirit and scope defined by the appended claims.

1. A gate driving method for a liquid crystal display panel, the liquid crystal display panel comprising a gate driving device for driving a plurality of output channels, and the gate driving method comprising:
dividing the gate driving device into a plurality of gate driving units according to positions of the plurality of output channels relative to a central output channel of the plurality of output channels; and
respectively setting bias currents outputted from the plurality of gate driving units such that the smaller an average distance of output channels driven by the gate driving unit from the central output channel is, the smaller the bias current outputted from the gate driving unit is set.

2. The gate driving method according to claim 1, wherein correspondence between the output channels of the gate driving device and the bias currents is stored in a look-up table.

3. The gate driving method according to claim 2, wherein corresponding bias currents are set by a timing controller using the look-up table.

4. The gate driving method according to claim 1, wherein corresponding bias currents are set by hardware pins.

5. The gate driving method according to claim 1, wherein the bias currents are classified into a maximum bias current, a medium bias current and a minimum bias current.

6. The gate driving method according to claim 1, wherein the bias currents are classified into a maximum bias current, a middle maximum bias current, a large bias current, a middle large bias current, a medium bias current, a middle medium bias current, a small bias current and a minimum bias current.

7. The gate driving method according to claim 6, wherein the gate driving device is divided into 1gate driving units,
the bias current outputted from the (8−i)-th gate driving unit is set equal to the bias current outputted from the (8+i)-th gate driving unit, and
the bias current outputted from the (7+i)-th gate driving unit is set smaller than the bias current outputted from the (8+i)-th gate driving unit, where 0<i<8, and i is an integer.

8. The gate driving method according to claim 1, wherein the bias currents are classified into n different kinds of bias currents.

9. The gate driving method according to claim 8, wherein the gate driving device is divided into (2n−1) gate driving units,
the bias current outputted from the (n−i)-th gate driving unit is set equal to the bias current outputted from the (n+i)-th gate driving unit, and
the bias current outputted from the (n+i−1)-th gate driving unit is set smaller than the bias current outputted from the (n+i)-th gate driving unit, where 0<i<n, and i and n are integers.

10. The gate driving method according to claim 9, wherein an average distance of the output channels driven by the (n+i−1)-th gate driving unit from the central output channel is smaller than an average distance of the output channels driven by the (n+i)-th gate driving unit from the central output channel.

11. A gate driving device for a liquid crystal display panel, the gate driving device used for driving a plurality of output channels and comprising:
a gate driving unit division part, configured to divide the gate driving device into a plurality of gate driving units according to positions of the plurality of output channels relative to a central output channel of the plurality of output channels; and
a bias current set part, configured to respectively set bias currents outputted from the plurality of gate driving units such that the smaller an average distance of output channels driven by the gate driving unit from the central output channel is, the smaller the bias current outputted from the gate driving unit is set.

12. The gate driving device according to claim 11, wherein correspondence between the output channels of the gate driving device and the bias currents is stored in a look-up table.

13. The gate driving device according to claim 12, wherein the bias current set part is configured to set corresponding bias currents using the look-up table.

14. The gate driving device according to claim 11, wherein the bias current set part is configured to set corresponding bias currents through hardware pins.

15. The gate driving device according to claim 11, wherein the bias currents are classified into a maximum bias current, a medium bias current and a minimum bias current.

16. The gate driving device according to claim 11, wherein the bias currents are classified into a maximum bias current, a middle maximum bias current, a large bias current, a middle large bias current, a medium bias current, a middle medium bias current, a small bias current and a minimum bias current.

17. The gate driving device according to claim 16, wherein the gate driving unit division part divides the gate driving device into 15 gate driving units,
the bias current outputted from the (8−i)-th gate driving unit is set equal to the bias current outputted from the (8+i)-th gate driving unit, and
the bias current outputted from the (7+i)-th gate driving unit is set smaller than the bias current outputted from the (8+i)-th gate driving unit, where 0<i<8, and i is an integer,

18. The gate driving device according to claim 11, wherein the bias currents are classified into n different kinds of bias currents, and the gate driving unit division part divides the gate driving device into (2n−1) gate driving units,
the bias current outputted from the (n−i)-th gate driving unit is set equal to the bias current outputted from the (n+i)-th gate driving unit, and
the bias current outputted from the (n+i−1)-th gate driving unit is set smaller than the bias current outputted from the (n+i)-th gate driving unit, where 0<i<n, and i and n are integers.

19. The gate driving device according to claim 18, wherein an average distance of the output channels driven by the (n+i−1)-th gate driving unit from the central output channel is smaller than an average distance of the output channels driven by the (n+i)-th gate driving unit from the central output channel.

20. A display apparatus, comprising pixel units and a gate driving device according to claim 11.
